(19) United States
(12) Patent Application Publication
(10) Pub. No.: US 2012/0151482 A1
(43) Pub. Date: Jun. 14, 2012

(54) SYSTEM AND METHOD FOR PROCESSING VIRTUAL MACHINE

(75) Inventors: Hyung Jik LEE, Daejeon (KR); Jeun Woo LEE, Daejeon (KR)

(73) Assignee: ELECTRONICS AND TELECOMMUNICATIONS RESEARCH INSTITUTE, Daejeon (KR)

(21) Appl. No.: 13/313,769

(22) Filed: Dec. 7, 2011

(30) Foreign Application Priority Data
Dec. 8, 2010 (KR) 10-2010-0125116

(51) Int. Cl. G06F 9/455

(52) U.S. Cl. 718/1

(57) ABSTRACT

Disclosed are a system and a method for efficiently managing virtual machine images that are varied for ever user, which generates a personal virtual machine image based on a shared virtual machine image using a copy on write method and processes the requested virtual machine through the generated image to support multi users. According to exemplary embodiments of the present invention, it is possible to integratively manage the same virtual machine and reduce the capacity of the virtual machine image in a data center, which reduces the cost for building the data center.

### CROSS-REFERENCE TO RELATED APPLICATIONS

This application claims priority to and the benefit of Korean Patent Application No. 10-2010-0125116 filed in the Korean Intellectual Property Office on DEC. 08, 2010, the entire contents of which are incorporated herein by reference.

### TECHNICAL FIELD

The present invention relates to a system and a method for processing a virtual machine, and more specifically, to a system and a method for processing a virtual machine by supporting multi users using a virtual machine image.

### BACKGROUND

As a desktop virtualization technology and a cloud computing technology are improved, many companies provide virtual computing systems to users instead of physical systems. In that case, a virtualization solution is installed in a data center, and users access their own virtual computing systems using a simple thin client or a terminal to do their job. Therefore, virtual machine images of the users and user data are stored in the data center. As the number of users is increased, the spaces for virtual machine images and data in the data center are correspondingly increased. However, since every user uses various user data, there is no option to reduce the space. In contrast, since users may use the same virtual machine for the virtual machine image, there is a chance to reduce the space. Therefore, it is required to efficiently manage the virtual machine images for the users.

### SUMMARY

The present invention has been made in an effort to provide a system and a method for processing a virtual machine by supporting multi users using a personal virtual machine image generated based on shared virtual machine images.

An exemplary embodiment of the present invention provides a system for processing a virtual machine, including: virtual machine providing units configured to provide virtual machines to users; a virtual machine selecting unit configured to select a specific virtual machine providing unit depending on a system load status of the virtual machine providing units when it is requested to execute the virtual machine; and a virtual machine executing unit configured to execute the virtual, machine requested by the virtual machine providing unit that is selected depending on the kind of requested virtual machine and whether a personal virtual machine image to execute the requested virtual machine exists or not.

The virtual machine executing unit may includes: a virtual machine determining unit configured to determine whether the requested virtual machine is a shared virtual machine or a personal virtual machine that is varied for every user; a determining unit of the presence of a personal virtual machine image configured to determine, if the requested virtual machine is a shared virtual machine, whether there is a personal virtual machine image generated from a shared virtual machine image for executing the shared virtual machine; a personal virtual machine image generating unit configured to generate a personal virtual machine image based on the shared virtual machine image if there is no personal machine image, and an executing unit configured to execute the requested virtual machine through the personal virtual machine image related to the requested virtual machine. The personal virtual machine image generating unit may generates the personal virtual machine image based on the shared virtual machine image by a copy on write method.

The virtual machine processing system may further includes: a virtual machine image storing unit configured to store the personal virtual machine image, and the personal virtual machine generating unit stores the generated virtual machine image in a directory of the virtual machine providing unit mounted in the virtual machine image storing unit.

The virtual machine selecting unit may includes: a system load calculating unit configured to calculate the system load status for every virtual machine providing unit when the virtual machine is requested; and a selecting unit configured to select a virtual machine providing unit having the smallest system load on the basis of the calculated result. The system load calculating unit may calculates at least one element of a memory usage rate, a CPU usage rate, and the number of run-time virtual machines as a system load status. The system load calculating unit may calculates the system load status taking a predetermined priority into consideration when the system load calculating unit calculates at least two elements.

The system for processing a virtual machine may further includes a terminal authenticating unit configured to authenticate a terminal that requests to execute the virtual machine.

Another exemplary embodiment of the present invention provides a method for processing a virtual machine, including: a virtual machine selecting step to select a specific virtual machine providing unit depending on a system load status of virtual machine providing units that provide virtual machines to users when it is requested to execute the virtual machine, and a virtual machine executing step to execute the virtual machine requested by the virtual machine providing unit that is selected depending on the kind of requested virtual machine and whether a personal virtual machine image to execute the requested virtual machine exists or not.

The virtual machine executing step may includes: a virtual machine determining step to determine whether the requested virtual machine is a shared virtual machine or a personal virtual machine that is varied for every user, a determining step of the presence of a personal virtual machine image to determine, if the requested virtual machine is a shared virtual machine, whether there is a personal virtual machine image generated from a shared virtual machine image for executing the shared virtual machine; a virtual machine image generating step to generate a personal virtual machine image based on the shared virtual machine image if there is no personal machine image, and an executing step to execute the requested virtual machine through the personal virtual machine image related to the requested virtual machine. The personal virtual machine image generating step may generates the personal virtual machine image based on the shared virtual machine image by a copy on write method. The personal virtual machine generating step may stores the generated virtual machine image in a directory of the virtual machine providing unit mounted in the virtual machine image storing unit storing the personal virtual machine image.

The virtual machine selecting step may includes: a system load calculating step to calculate the system load status for every virtual machine providing unit when the virtual machine is requested; and a selecting step to select a virtual machine providing unit having the smallest system load on the basis of the calculated result. The system load calculating step may calculates at least one element of a memory usage rate, a CPU usage rate, and the number of run-time virtual machine as a system load status. Moreover, the system load calculating step calculates the system load status taking a predetermined priority into consideration when the system load calculating unit calculates at least two elements.

The method for processing a virtual machine may further includes a terminal authenticating unit to authenticate a terminal that requests to execute the virtual machine.

According to exemplary embodiments of the present invention, it is possible to allow the contents of application programs which are performed in the plurality of operating systems through a display device to be simultaneously checked by simultaneously displaying a plurality of operating system screens on a display device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram schematically showing a virtual machine processing system according to an exemplary embodiment of the present invention.

FIG. 2 and FIG. 3 are block diagrams showing an internal structure of the virtual machine processing system in detail.

FIG. 4 and FIG. 5 are configuration diagrams showing a system that manages a virtual machine image according to an exemplary embodiment of the invention.

FIG. 6 is a flowchart showing a virtual machine processing method according to an exemplary embodiment of the invention.

FIG. 7 is a flowchart showing a virtual machine image generating method of a virtual machine image managing server.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First, when adding reference numerals on the components of each drawing, it should be aware that the same components have the same numerals even if you see the other drawing. In a description of the invention, if the relevant known configuration or specific details about functions can blur the gist of the present invention, the detailed description is omitted and terms described in the singular may include the concept of a multi. Exemplary embodiments of the present invention will be described later but the technical idea of the invention is not defined or limited to them, and is transformed variously by one skilled in the art.

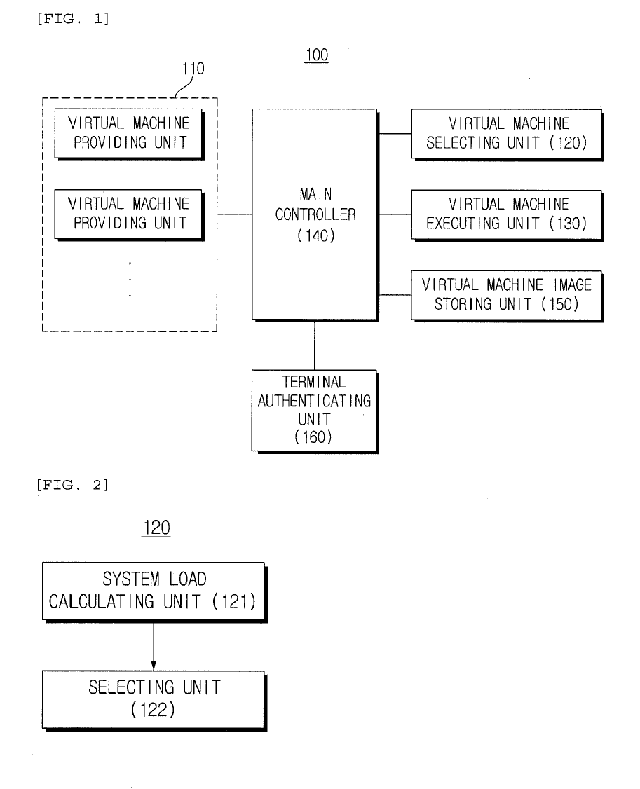

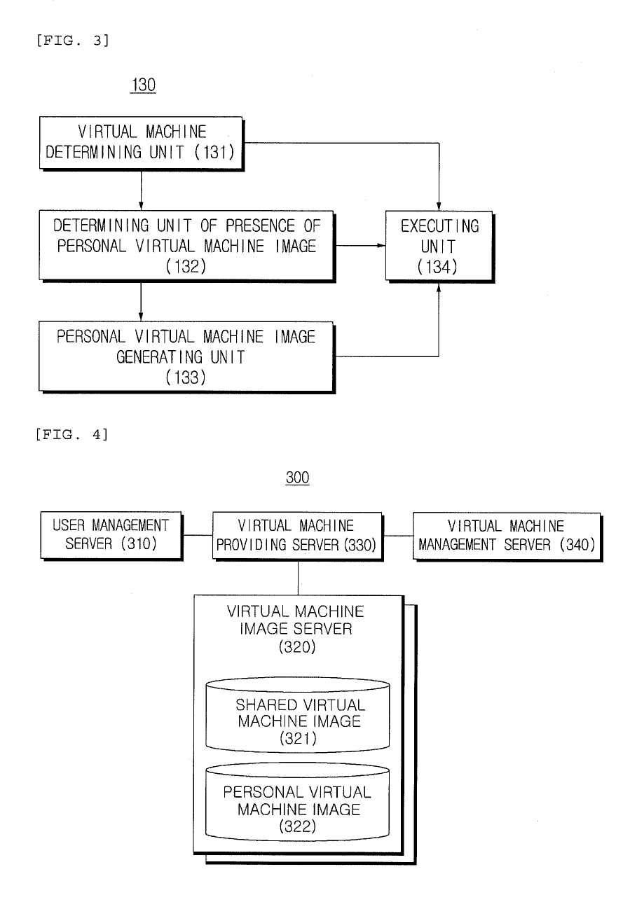

FIG. 1 is a block diagram schematically showing a virtual machine processing system according to an exemplary embodiment of the present invention. FIG. 2 and FIG. 3 are block diagrams showing an internal structure of the virtual machine processing system in detail. With reference to FIGS. 1 to 3, an exemplary embodiment will be described.

Referring to FIG. 1, a virtual machine processing system 100 includes virtual machine providing units 110, a virtual machine selecting unit 120, a virtual machine executing unit 130, and a main controller 140.

The virtual machine providing units 110 are configured to provide virtual machines to users. The virtual machine providing unit of the exemplary embodiment can be embodied as a virtual machine providing server.

The virtual machine selecting unit 120 is configured to select a specific virtual machine providing unit depending on a system load status of the virtual machine providing unit 110 when it is requested to execute the virtual machine. The virtual machine selecting unit 120 may include a system load calculating unit 121 and a selecting unit 122 as shown in FIG. 2. The system load calculating unit 121 is configured to calculate the system load status for every virtual machine providing unit when the virtual machine is requested. The system load calculating unit 121 calculates at least one element of a memory usage rate, a CPU usage rate, and the number of run-time virtual machines as a system load status. When the system load calculating unit 121 calculates at least two elements, the system load calculating unit 121 calculates the system load status taking a predetermined priority into consideration. The selecting unit 122 is configured to select a virtual machine providing unit having the smallest system load on the basis of the calculated result.

The virtual machine executing unit 130 is configured to execute the virtual machine requested by the virtual machine providing unit that is selected depending on the kind of requested virtual machine and whether a personal virtual machine image to execute the requested virtual machine exists or not. As shown in FIG. 3, the virtual machine executing unit 130 includes a virtual machine determining unit 131, a determining unit 132 of the presence of a personal virtual machine image, a personal virtual machine image generating unit 133, and an executing unit 134. The virtual machine determining unit 131 is configured to determine that the requested virtual machine is a shared virtual machine or a personal virtual machine that is varied for every user. The determining unit 132 of personal virtual machine image is configured to, when the requested virtual machine is a shared virtual machine, determine that there is a personal virtual machine image generated from a shared virtual machine image for executing the shared virtual machine. If there is no personal virtual machine image, the personal machine image generating unit 133 is configured to generate a personal virtual machine image based on the shared virtual machine image. The personal virtual machine image generating unit 133 may generates the personal virtual machine image based on the shared virtual machine image using a copy on write method. The executing unit 134 is configured to execute a virtual machine requested by a personal virtual machine image related to the requested virtual machine. In the exemplary embodiment, if the requested virtual machine is a personal virtual machine, or if there is a personal virtual machine image to execute the requested virtual machine, or if a personal virtual machine image is generated, the executing unit 124 executes the requested virtual machine using the personal virtual machine image.

In the exemplary embodiment, the virtual machine selecting unit 120 and the virtual machine executing unit 130 may be embodied as a virtual machine management server.

The main controller 140 is configured to control the overall operation of the respective units that constitutes the virtual machine processing system 100.

The virtual machine processing system 100 further includes a virtual machine image storing unit 150. The virtual machine image storing unit 150 stores the personal virtual machine image. The personal virtual machine image generating unit 133 stores the generated virtual machine image in a directory of the virtual machine providing unit mounted in the virtual machine image storing unit to allow the virtual machine image to be automatically stored in the virtual machine image storing unit 150. In the exemplary embodiment, the virtual machine image storing unit 150 may be embodied as a virtual machine image server.

The virtual machine processing system 100 further includes a terminal authenticating unit 160. The terminal authenticating unit 160 is configured to authenticate a terminal that requests to execute a virtual machine. In the exemplary embodiment, the terminal authenticating unit 160 may be embodied as a user management server.

The virtual machine processing system 100 according to the exemplary embodiment generates a personal virtual machine image using a copy on write (COW) method and efficiently manages the virtual machine image for multi users. The virtual machine processing system 100 installs OS such as Windows XP, Windows 7, or Ubuntu, which are widely used by users in the data center as a shared virtual machine image in advance. The virtual machine processing system 100 includes a server that manages users who use a virtual machine in the data center, a virtual machine managing server that manages the virtual machines, a virtual machine providing server in which the virtual machines are actually driven, and a virtual machine image server in which the virtual machine images are stored. When a user logs in the virtual machine managing server using a terminal to request to use the virtual machine, the virtual machine processing system 100 uses the above configuration to generate a personal virtual machine image for a user from a shared virtual machine image using a copy on write method, boots up the generated virtual machine to show it onto a user's terminal. If the copy on write method is used to generate a personal virtual machine image, only a part that is corrected by a user is stored as the virtual machine image, and an uncorrected part utilizes a shared virtual machine image so that multi users can share the shared virtual machine image. For example, when a window XP environment having 100 GB of capacity is provided to 10 users as a virtual machine, if the copy on write method is not used, 1000 GB of space is required to provide a virtual machine to the users. However, if the copy on write method is used, only one shared virtual machine having 100 GB of space and 10 personal virtual machines having several hundred KB space is needed. In order to provide a new virtual machine image to a user, personal virtual machine images as many as the number of users should be installed, which takes a lot time to install. On the contrary, if the virtual machine image is managed according to the exemplary embodiment, the space for data in the data center can be reduced. In case of a new virtual machine, the users can use the personal virtual machine with only one installation, which allows the data center to be easily managed.

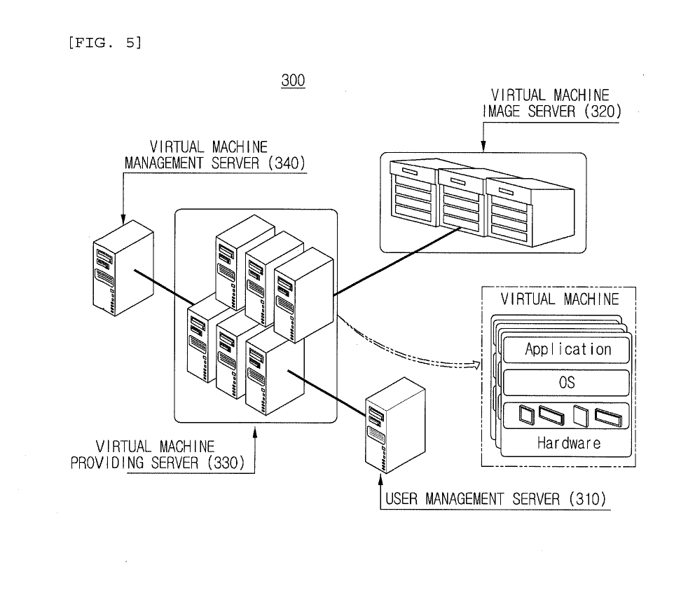

FIG. 4 and FIG. 5 are configuration diagrams showing a system that manages a virtual machine image according to an exemplary embodiment of the invention. FIG. 4 shows the block diagram of the system, and FIG. 5 shows the real system that embodies the exemplary embodiment. Referring to FIGS. 4 and 5, the virtual machine image management system 300 includes a user management server 310 on which a user database, a user authentication and user log in/off management module are installed, a virtual machine image server 320, a plurality of virtual machine providing servers 330 in which the virtual machine is actually operated, and a virtual machine management server 340 in which a web-based virtual machine management tool is installed to manage the virtual machine. In the virtual machine image server 320, a shared virtual machine image 321 commonly used by the users, such as Windows XP, Windows 7 and a personal virtual machine image 322 generated by a copy on write method based on the shard virtual machine image are installed.

If the user wants to use the virtual machine in the system 300, first of all, the user should access the virtual machine management tool installed in the virtual machine management server 340 through a browser provided by the thin client or terminal using a web. When the user logon screen is displayed, the user inputs his/her ID and password. In this case, it is assumed that the user information is previously stored in the database of the user management server 310. The virtual machine management server 340 encrypts the input information to transmit the encrypted information to the user management server 310. The user management server 310 decodes the data to perform user authentication. Only an authenticated user can display an initial screen of the virtual machine management tool on the thin client or the terminal of the user. The virtual machine management tool shows information of an available virtual machine to the user. In this case, the virtual machine shows a virtual machine registered for a shared user and a list of logged-on personal virtual machine of the user. Thereafter, the user selects a virtual machine that he/she wants to use and requests to execute the virtual machine. The virtual machine allows the virtual machine managing server 340 to check the system loads (memory usage rate, CPU usage rate, the number of run time virtual machines) and select a virtual machine providing server 330 having the smallest load and then the virtual machine is executed in the virtual machine providing server 330 having the smallest load. In this case, it is assumed that all virtual machine providing server 330 is connected to the virtual machine image server 320 through a network and the image directory of the virtual machine image server 320 is mounted through the network.

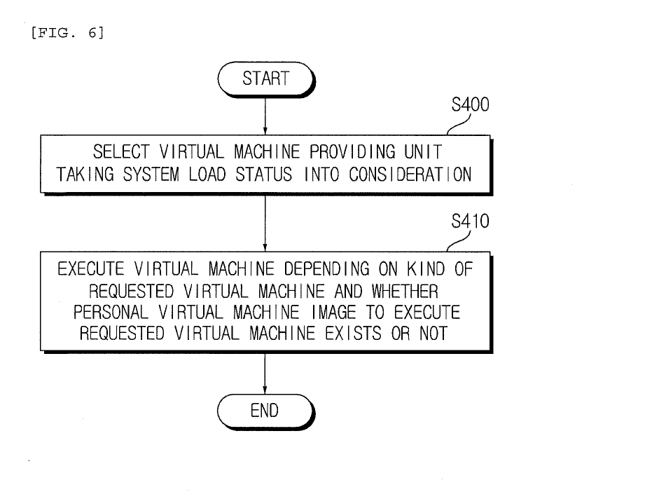

Next, a virtual machine processing method of the virtual machine processing system will be described with reference to FIG. 6. FIG. 6 is a flowchart showing a virtual machine processing method according to an exemplary embodiment of the invention.

First, if it is requested to execute the virtual machine, a specific virtual machine providing unit is selected according to a system load status of virtual machine providing units that provide virtual machines to users (virtual machine selection step, S400). In the exemplary embodiment, the virtual machine selection step S400 includes a system load calculation step and a selection step. If the virtual machine is requested, the system load calculation step calculates a system load status for every virtual machine providing unit. The system load calculation step calculates at least one of a memory usage rate, a CPU usage rate, and the number of run-time virtual machines as the system load status. When the system load calculation step calculates at least two elements, the system load calculation step calculates the system load status taking the predetermined priority into consideration. The selection step selects a virtual machine providing unit having the smallest system load on the basis of the calculated result.

Next, the requested virtual machine is executed through the virtual machine providing unit selected depending on a kind of requested virtual machine and whether a personal virtual machine image to execute the requested virtual machine exists or not (virtual machine executing step S410). In the exemplary embodiment, the virtual machine executing step S410 may include a virtual machine determining step, a determining step of the presence of a personal virtual machine image, a personal virtual machine image generating step, and an executing step. The virtual machine determining unit determines whether the requested virtual machine is a shared virtual machine or a personal virtual machine that is varied for every user. The determining step of the existence of a personal virtual machine image determines, when the requested virtual machine is a shared virtual machine, whether there is a personal virtual machine image generated from a shared virtual machine image to execute the shared virtual machine. If there is no personal virtual machine image, the personal machine image generating step generates a personal virtual machine image based on the shared virtual machine image. The personal virtual machine image generating step generates the personal virtual machine image based on the shared virtual machine image using a copy on write method. The personal virtual machine image generating step stores a virtual machine image generated to a directory of the virtual machine providing unit mounted in the virtual machine image storing unit storing a personal virtual machine image. The executing step executes the requested virtual machine using the personal virtual machine image related to the requested virtual machine.

In the meantime, the method further includes a terminal authenticating step. The terminal authenticating step authenticates a terminal that requests to execute the virtual machine. The terminal authenticating step may proceed together with the virtual machine selecting step S400, but the present invention is not limited thereto. For example, the terminal authenticating step may proceed before the virtual machine selecting step.

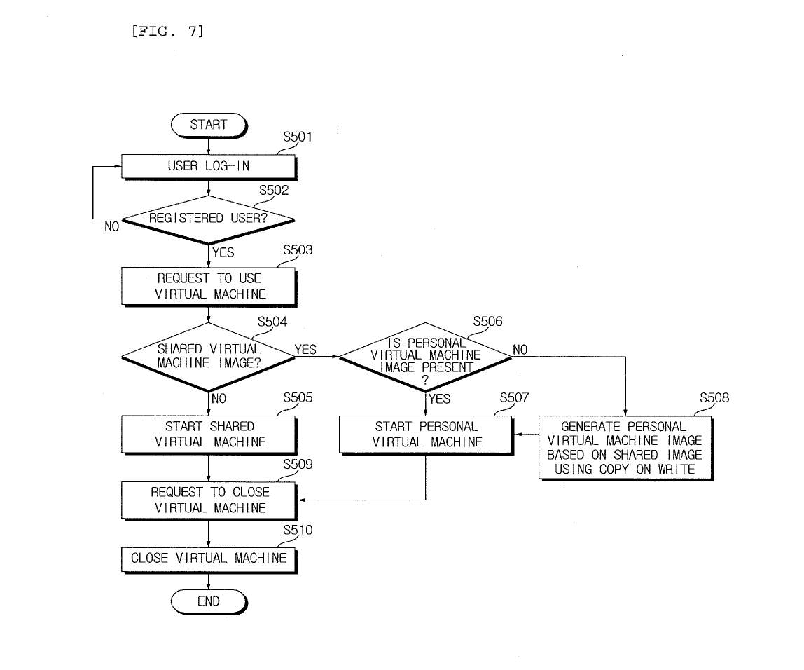

FIG. 7 is a flowchart showing a virtual machine image generating method of a virtual machine image managing server. When the user is authenticated by the user management server (S501 and S502), the authenticated user can request to use the virtual machine (S503). Then, the virtual machine management server calculates the system load of all virtual machine providing server. The priority for the system load calculation is given to a memory usage rate, a CPU usage rate, and the number of run-time virtual machines and a virtual machine providing server having the smallest load is selected. Thereafter, the kind of selected virtual machine is checked. If the selected virtual machine is its own virtual machine (S504), the virtual machine is executed as it is (S505). The screen for the executed virtual machine is displayed on a monitor of a thin client or a terminal of the accessed user. If the selected virtual machine is a shared virtual machine (S504), the virtual machine management server checks if there is a personal virtual machine image of the user who made the requests (S506). If the personal virtual machine image exists, the virtual machine is selected and executed (S507). If the personal virtual machine image does not exist, a new personal virtual machine image is generated based on the shared virtual machine image using a copy on write method (S508). The generated personal virtual machine image is stored in a directory of the selected virtual machine providing server. Since the directory is mounted in the virtual machine image server, the directory is also automatically stored in the virtual machine image server. When the user, who is using the virtual machine in the accessed terminal, requests to close, the virtual machine management server closes the requested virtual machine (S510).

Since the personal virtual machine image generated by the copy on write method is based on the shared virtual machine image, all personal virtual machine images that are generated by the method are initially the same virtual machines. Thereafter, only a part that is changed according to the user is stored in the personal virtual machine image, and the capacity is also changed depending on the part that is changed by the user. Therefore, user data is stored only in the user's personal virtual machine, which allows data security to be improved. By the method, as compared with the conventional virtual machine image managing method that allows the user to install the user's virtual machine image through the original CD or additionally allocates disk images to the virtual machine, it is possible to reduce the time of generating a virtual machine. Since the capacity is varied depending on the changed part, it is further possible to reduce the usage rate of the disk in the data center. Actually, the personal virtual machine image generated by the copy on write method has initially several hundred KB of capacity regardless of the capacity of shared image.

The present invention can be applied to a multi user support virtual machine image management system or collaborative VM system for SoD (System on demand) service.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A system for processing a virtual machine, comprising:
virtual machine providing units configured to provide virtual machines to users;
a virtual machine selecting unit configured to select a specific virtual machine providing unit depending on a system load status of the virtual machine providing units when it is requested to execute the virtual machine; and
a virtual machine executing unit configured to execute the virtual machine requested by the virtual machine providing unit that is selected depending on the kind of requested virtual machine and whether a personal virtual machine image to execute the requested virtual machine exists or not.

2. The system of claim 1, wherein the virtual machine executing unit includes:
a virtual machine determining unit configured to determine whether the requested virtual machine is a shared virtual machine or a personal virtual machine that is varied for every user;
a determining unit of the presence of a personal virtual machine image configured to determine, if the requested virtual machine is a shared virtual machine, whether there is a personal virtual machine image generated from a shared virtual machine image for executing the shared virtual machine;
a personal virtual machine image generating unit configured to generate a personal virtual machine image based on the shared virtual machine image if there is no personal machine image; and
an executing unit configured to execute the requested virtual machine through the personal virtual machine image related to the requested virtual machine.

3. The system of claim 2, wherein the personal virtual machine image generating unit generates the personal virtual machine image based on the shared virtual machine image by a copy on write method.

4. The system of claim 2, further comprising:
a virtual machine image storing unit configured to store the personal virtual machine image,
wherein the personal virtual machine generating unit stores the generated virtual machine image in a directory of the virtual machine providing unit mounted in the virtual machine image storing unit.

5. The system of claim 1, wherein the virtual machine selecting unit includes:
a system load calculating unit configured to calculate the system load status for every virtual machine providing unit when the virtual machine is requested; and
a selecting unit configured to select a virtual machine providing unit having the smallest system load on the basis of the calculated result.

6. The system of claim 5, wherein the system load calculating unit calculates at least one element of a memory usage rate, a CPU usage rate, and the number of run-time virtual machines as a system load status.

7. The system of claim 6, wherein the system load calculating unit calculates the system load status taking a predetermined priority into consideration when the system load calculating unit calculates at least two elements.

8. The system of claim 1, further comprising:
a terminal authenticating unit configured to authenticate a terminal that requests to execute the virtual machine.

9. A method for processing a virtual machine, comprising:
a virtual machine selecting step to select a specific virtual machine providing unit depending on a system load status of virtual machine providing units that provide virtual machines to users when it is requested to execute the virtual machine; and
a virtual machine executing step to execute the virtual machine requested by the virtual machine providing unit that is selected depending on the kind of requested virtual machine and whether a personal virtual machine image to execute the requested virtual machine exists or not.

10. The method of claim 9, wherein the virtual machine executing step includes:
a virtual machine determining step to determine whether the requested virtual machine is a shared virtual machine or a personal virtual machine that is varied for every user;
a determining step of the presence of a personal virtual machine image to determine, if the requested virtual machine is a shared virtual machine, whether there is a personal virtual machine image generated from a shared virtual machine image for executing the shared virtual machine;
a virtual machine image generating step to generate a personal virtual machine image based on the shared virtual machine image if there is no personal machine image; and
an executing step to execute the requested virtual machine through the personal virtual machine image related to the requested virtual machine.

11. The method of claim 10, wherein the personal virtual machine image generating step generates the personal virtual machine image based on the shared virtual machine image by a copy on write method.

12. The method of claim 10, wherein the personal virtual machine generating step stores the generated virtual machine image in a directory of the virtual machine providing unit mounted in the virtual machine image storing unit storing the personal virtual machine image.

13. The method of claim 9, wherein the virtual machine selecting step includes:
a system load calculating step to calculate the system load status for every virtual machine providing unit when the virtual machine is requested; and
a selecting step to select a virtual machine providing unit having the smallest system load on the basis of the calculated result.

14. The method of claim 13, wherein the system load calculating step calculates at least one element of a memory usage rate, a CPU usage rate, and the number of run-time virtual machine as a system load status.

15. The method of claim 14, wherein the system load calculating step calculates the system load status taking a predetermined priority into consideration when the system load calculating unit calculates at least two elements.

16. The method of claim 9, further comprising:
a terminal authenticating unit to authenticate a terminal that requests to execute the virtual machine.
